(19) United States
(12) Patent Application Publication
(10) Pub. No.: US 2022/0089414 A1
(43) Pub. Date: Mar. 24, 2022

(54) LIFTING AND TILTING DEVICE

(71) Applicant: Parmerit Inc., Strathroy (CA)

(72) Inventors: David John DEGROOT, Strathroy (CA); David James LOCKIE, Strathroy (CA)

(21) Appl. No.: 17/483,108

(22) Filed: Sep. 23, 2021

Related U.S. Application Data
(60) Provisional application No. 63/082,623, filed on Sep. 24, 2020.

(51) Int. Cl. B66C 1/02; B66C 1/06; B66C 13/08

(52) U.S. Cl. CPC B66C 1/0262; B66C 13/08; B66C 1/06; B66C 1/0212

(57) ABSTRACT

The invention provides a lifting and tilting device. The lifter has an elongated frame having one or more horizontal lifting points and one or more tilt lifting points to which a lift shackle is attached. The frame provides multiple attachment points for lifters including magnetic lifters or suction lifters allowing the device to be adjusted to lift a variety of shaped and sized ferrous and non-ferrous objects.

This application claims priority from U.S. provisional application 63/082,623, filed Sep. 23, 2021, the entire contents of which are incorporated herein by reference.

### FIELD OF THE INVENTION

This invention pertains generally to lifting a load typically with a crane or other lifting device and, more particularly to a lifting and tilting device.

### BACKGROUND OF THE INVENTION

In many industries, it is necessary move, lift or tilt objects of various shapes and sizes. The use of lifting devices that reversibly attach to materials for the lifting of materials is well known in the prior art.

These lifting devices reversibly couple to the material to be lifted using magnets including permanent magnets and electromagnets for ferrous metals or suction cups including manual and vacuum suction devices for non-ferrous materials (ex. glass, plastic, aluminum, stainless steel, wood, cement etc.).

Lifting devices are general configured to lift material simply up and down in the horizontal position, or to lift it from the horizontal position to the vertical called a “tilt lift”. There exists a need for a single lifting device that can be easily adjusted to lift various objects either with a straight horizontal lift or a tilt lift, i.e. there exists a need for a combination lifting device.

Also, these devices are normally suited for lifting specific sized and shaped objects and are not easy adjustable to specifically shapes and also various sizes. There exists a need for a device that can be adjusted to lift a greater variation of shapes and sizes in objects.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a lifting and tilting device. In accordance with an aspect of the present invention, there is provided a lifting device comprising an elongated frame, the elongated frame having a first end, body and a second end, the first end extending at an obtuse angle from the body and having one or more tilt lifting points configured to receive a lift shackle, the body comprising one or more reversible coupling device attachment points and one or more horizontal lifting points configured to receive a lift shackle; at least one lift shackle connected to a tilt lifting point or a horizontal lifting point; and at least one reversible coupling device. In some embodiments, the reversible coupling device is an area gripping device, automatic suction cup device, electromagnetic device, manual suction cup device, or manual magnetic device.

In accordance with another aspect of the present invention, there is provided a lifting device comprising an elongated flat frame, the elongated flat frame having a first end, body and a second end, the first end extending at an obtuse angle from the body and having one or more tilt lifting points configured to receive a lift shackle, the body comprising one or more magnet attachment points and one or more horizontal lifting points configured to receive a lift shackle; at least one lift shackle connected to a tilt lifting point or a horizontal lifting point; and at least one magnetic lifter. In some embodiments, the elongated flat frame further comprises and extended platform for mounting magnetic lifters.

In accordance with another aspect of the present invention, there is provided a lifting device comprising an elongated flat frame, the elongated flat frame having a first end, body and a second end, the first end extending at an obtuse angle from the body and having one or more tilt lifting points configured to receive a lift shackle, the body comprising one or more magnet attachment points and one or more horizontal lifting points configured to receive a lift shackle; at least one lift shackle connected to a tilt lifting point or a horizontal lifting point; and at least one suction cup lifter. In some embodiments, the elongated flat frame further comprises and extended platform for suction cup lifters.

The lifting device of the present invention provides a combination of tilt lift and horizontal lift function in one unit and is configurable to accommodate various shapes and sizes of objects. The use of multiple reversible coupling devices on the lifting device securely hold the object to be lifted and/or tilted.

The lifting device is configured such that the locations of the reversible coupling devices and/or lift shackles are easily adjusted to allow for a wide array of material sizes and shapes to be lifted with one unit. In some embodiments, quick adjustment to adapt the lifting device to suit for size and shape is facilitated by the use of removable pins and shackles.

The use of at least two reversible coupling devices in combination with the strategically placed mechanical features, allows for various shaped materials including but not limited to round and square as well as hollow and solid to be lifted and/or titled.

The interchangeability of reversible couple devices including but not limited to magnets and suction cups, allows the device to lift various metal materials, ferrous and non-ferrous, and other non-metals including glass and plastics etc.

### BRIEF DESCRIPTION OF THE DRAWINGS

These and other features of the invention will become more apparent in the following detailed description in which reference is made to the appended drawings.

FIG. 1 is a view of lifting devices of the invention equipped with area gripping devices (A), automatic suction cup devices (B), electromagnetic devices (C), manual suction cup devices (D), and manual magnetic lifters (E).

FIG. 2 is two isometric views of the lifting device (10) equipped with manual magnetic devices or magnetic lifters with a metal disk.

FIG. 3 is a side view of the lifting device (10) in accordance with one embodiment of the invention detailing the elongated flat frame (20), tilt lifting points (30) with installed lift shackle (40), horizontal lifting points (50) with installed lift shackle (40), one or more magnetic attachment points (60) with associated magnetic lifter(s) (70) and mechanical lift support (80).

FIG. 4 is a back view of the lifting device (10) shown in FIG. 3

FIG. 5 is a top view of the lifting device (10) shown in FIG. 3 and FIG. 4.

FIG. 6 is a detailed view of circled area A shown in FIG. 3.

FIG. 7 is a detailed view of circled area B shown in FIG. 3.

FIG. 8 is a detailed view of circled area C shown in FIG. 3.

FIG. 9 is a detailed view of circled area D shown in FIG. 3.

FIG. 10 details the embodiment of the lifting device shown in FIGS. 3-5 adjusted to lift different shaped and sized objects.

FIG. 11 details alternative embodiments of the lifting device.

FIG. 12 details various views of an alternative embodiment of the lifting device.

FIG. 13 details the steps of lifting an object using the lifting device shown in FIGS. 3-5.

FIG. 14 details the steps of lifting and tilting an object using the lifting device shown in FIGS. 3-5.

### DETAILED DESCRIPTION OF THE INVENTION

This invention provides a lift device that is adjustable to lift various sizes and shapes of materials including but not limited to, ferrous material including steel and iron, and non-ferrous or non-magnetic material including glass, plastics, wood, aluminum, carbon fiber sheets, marble and other materials. The lift device uses a combination of mechanical features and one or more reversible coupling device(s) including manually activated magnets, electromagnets, suction cups and vacuum lift devices amongst others to lift the material. The lift device is configured to be lifted, hoisted or titled using a pulley system or crane. In some embodiments, the lift device and optionally reversible coupling device(s) thereof are configured be lifted with other devices as well, for example pick and places systems, portable cranes, indoor or out door, hydraulic lift equipment, custom automation or industrial robots.

The lift device is configured to be easily adjusted for size, orientation and lift angle of object to be lifted.

In some embodiments, the lift device is configured to allow for adjustment of placement and/or number of the reversible coupling device(s) to accommodate a variety of shaped and sized objects to be lifted.

The reversible coupling device(s) include magnets or electromagnets for ferrous metals, suction cups, and vacuum suction devices for non-ferrous materials (ex. glass, plastic, aluminum, stainless steel, wood cement etc.). In some embodiments, the magnets are industrial lift magnets.

The lifting device comprises a generally elongated frame that extends from its base and includes an obtuse angled extension. The body or main part of the frame includes one or more reversible coupling device(s) points and one or more lifting points including tilt lifting points (30) and horizontal lifting points (50). The body or main part of the frame can be of various configurations. In some embodiments, the body of the frame is substantially, long and flat. In other embodiments, the body or main part of the frame includes an expanded platform for mounting of reversible coupling device(s), optionally the expanded platform is re-enforced with ribbing.

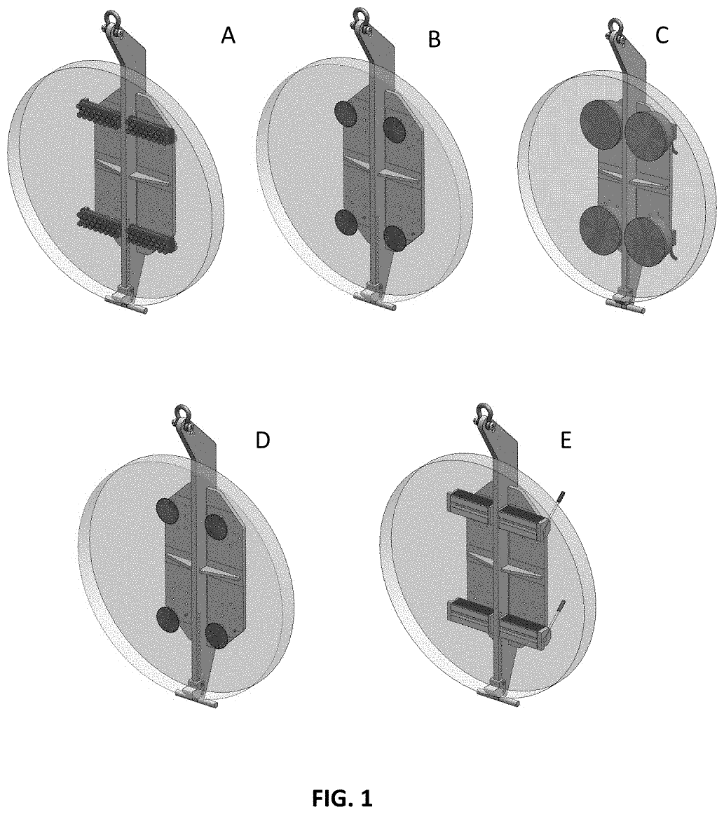

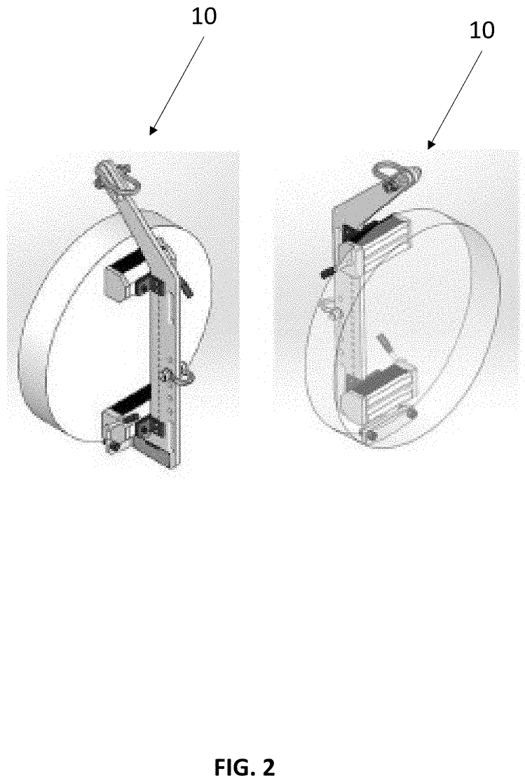

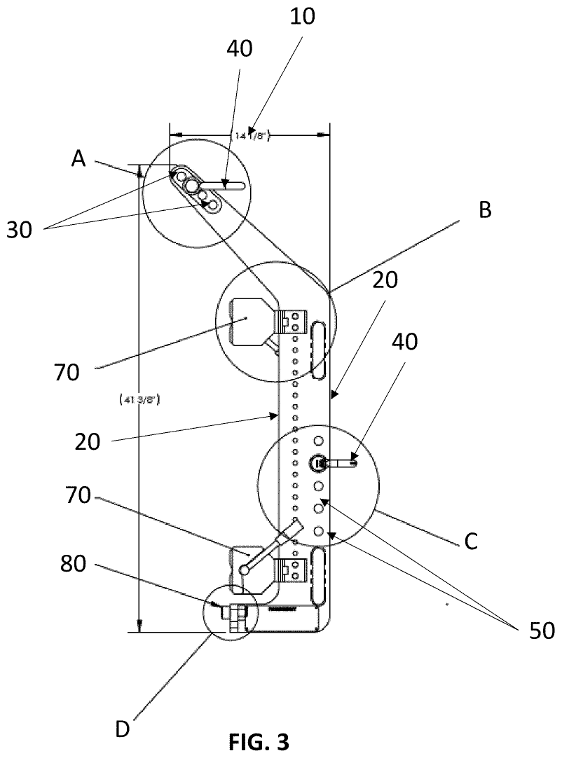

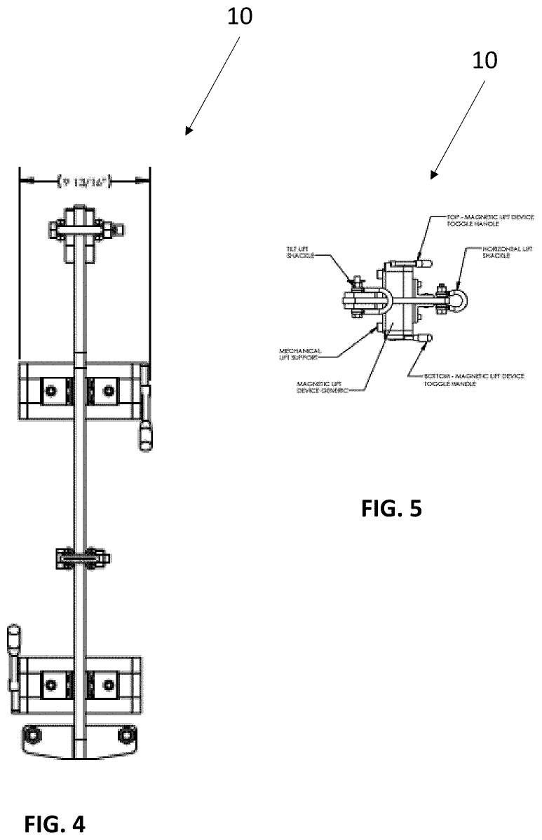

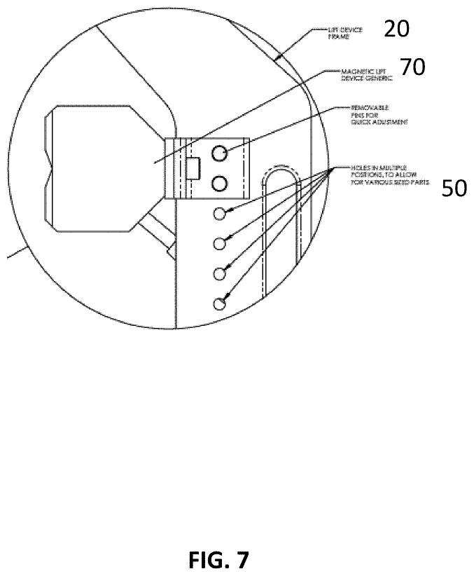

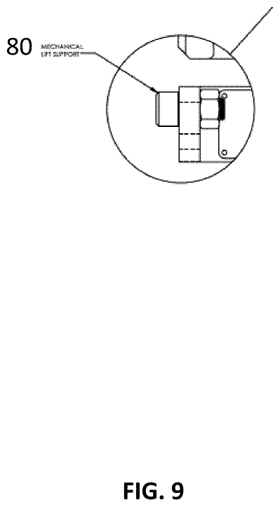

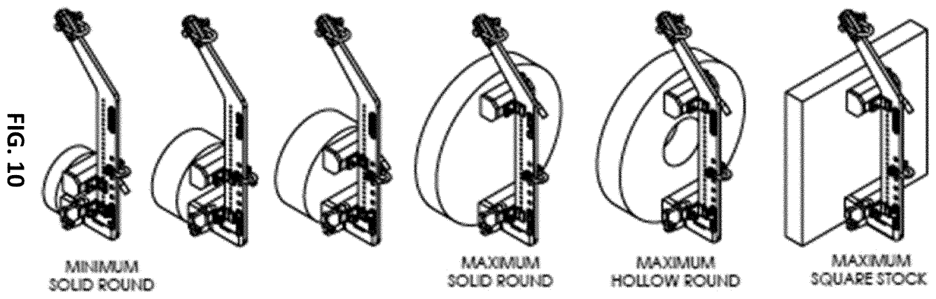

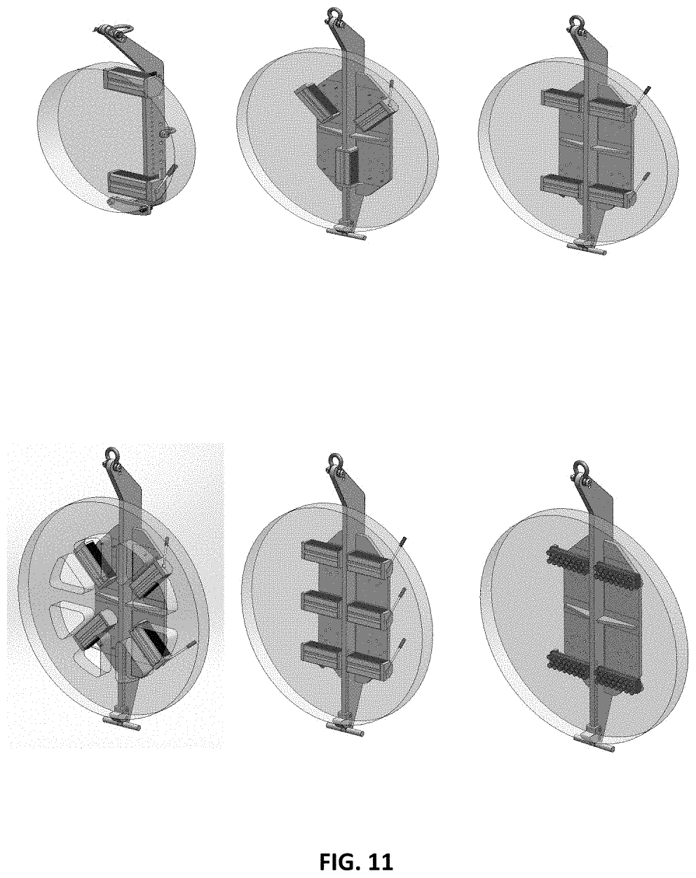

Referring to FIGS. 1-11, the lifting device (10) comprises a generally elongated flat frame (20) that extends generally straight from its base to an obtuse angled extension. The body or main part of the frame includes one or more reversible coupling device attachment points (60) and one or more lifting points including tilt lifting points (30) and horizontal lifting points (50).

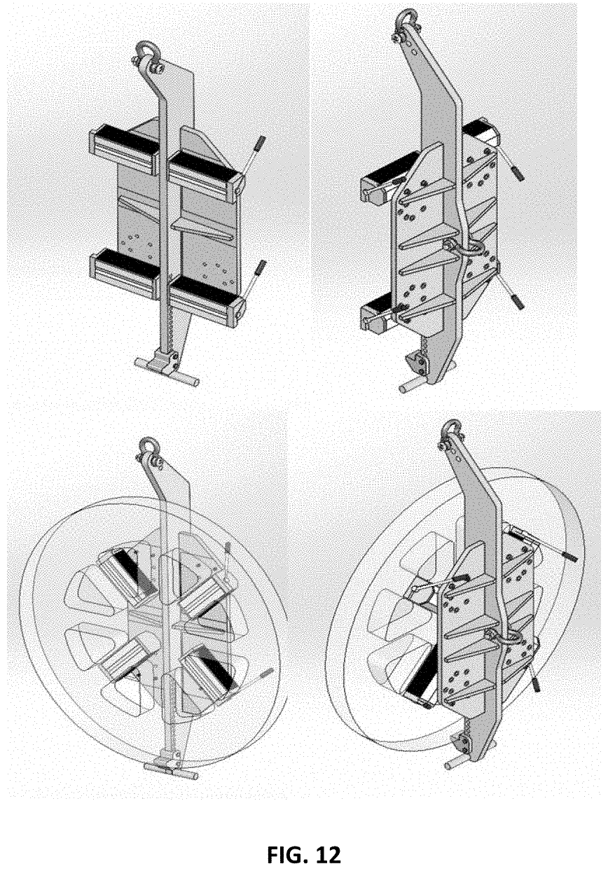

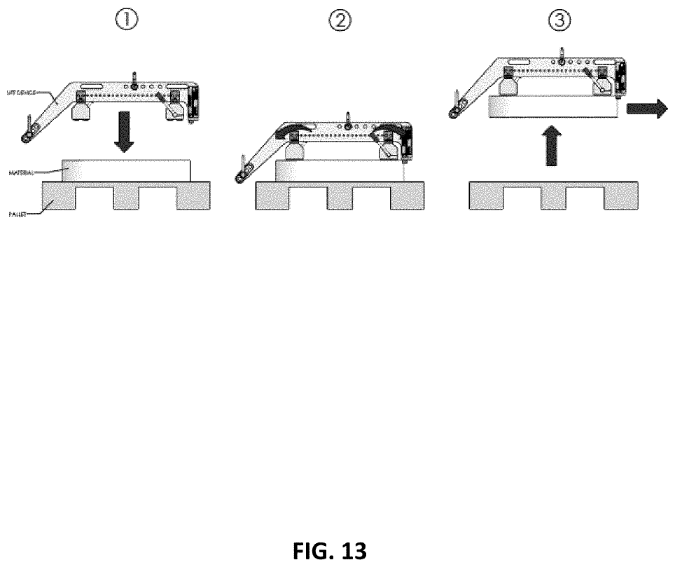

Referring to FIGS. 12 and 13, in alternative embodiments, the frame body or main part includes an expanded platform that includes holes for the mounting reversible coupling devices. The expanded platform may be various shapes and optionally may include ribbing. The expanded platform includes various attachment points for the reversible coupling device.

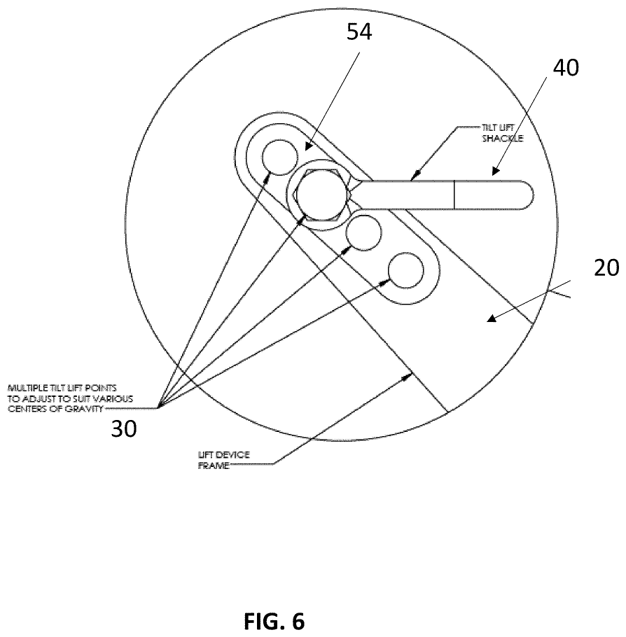

The frame, including the platform in some embodiments, is generally manufactured from steel or other appropriate materials. The frame and associated components are optionally painted or otherwise treated to limit corrosion. The magnetic attachment points (60) and/or lifting points are one or more holes or openings in the frame that in some embodiments are reinforced. As shown in FIG. 5, the lifting points, in some embodiments, are holes (30) in the frame reinforced with a metal reinforcing plate (54). In some embodiments, the holes can be reinforced with more than one metal reinforcing plate such that the frame is sandwiched between metal reinforcing plates.

In some embodiments, the frame includes a mechanical lift support (80) and/or foot. Optionally, the mechanical lift support (80) and/or foot can be configured as a pivot to facilitate tilting.

In some embodiments, the foot includes or is configured to be equipped with rollers or wheels.

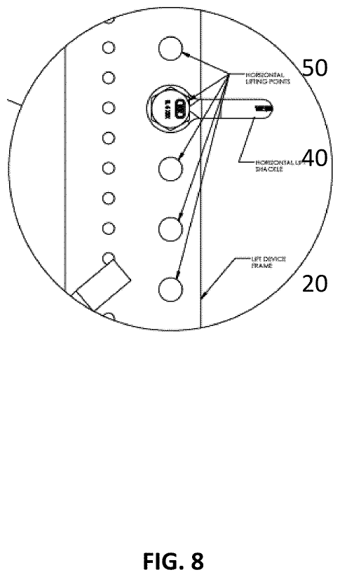

Referring to FIGS. 6 and 8, pivotally attached to the frame at one or more lifting points are shackle(s) (40). The shackle(s) are pivotally attached to the frame by appropriate means including fasteners, pins, shafts and bolt. In the illustrated embodiments, the frame includes multiple lifting and tilt lifting points. Selection of appropriate lifting or tilt lifting point is based on center of gravity of objected being lifted or tilted or other factors apparent to one of ordinary skill in the art. Appropriate shackle(s) are known in the art.

Referring to FIG. 6, one or more magnetic lift devices (70) are attached to the frame. In the illustrated embodiment, the magnetic lifter (70) is reversibly attached to the frame using pins or bolts that insert through holes in the attachment means of magnetic lifter and the magnetic attachment points. In some embodiments, the attachment means comprises appropriately sized brackets. Optionally, the brackets and/or the frame or part thereof is coated or otherwise treated to facilitate sliding of the magnetic lifter up and down the frame.

In an alternative embodiment, the frame is equipment with a track or spine and the attachment means of the magnetic lifting devices are configured to move on the track or spine. Once positioned, the attachment means and the associated magnetic lifter are locked in place.

Referring to FIG. 10, the position of the magnetic lifters is adjusted based on the size and shape of the ferrous object to be lifted.

Any generic lifter including magnetic or suction lifters can be modified to allow for attachment to the frame by adding appropriate attachment means.

In some embodiments, the magnetic lifter comprises a neodymium magnet in a housing. The bottom surface of the magnetic lifter is optionally grooved.

In some embodiments, the manually activated magnetic lifter comprises a toggle or on/off handle to engage and release the magnet. Optionally, the magnetic lifter handle is lockable in the on and/or off position. In some embodiments, the handle is detachable.

The lift capacity of the lifting device may be increased or decreased as appropriate based on the lifter(s) that are installed on the frame.

FIG. 13 shows an example of a horizontal lift of a ferrous object using one embodiment of the lift device. Referring to FIG. 13, the lifting device is position over the objected and lowered into place. The magnets are engaged and the object is lifted off the pallet and moved using a pulley or crane operatively associated with a shackle attached to the horizontal lifting points (50).

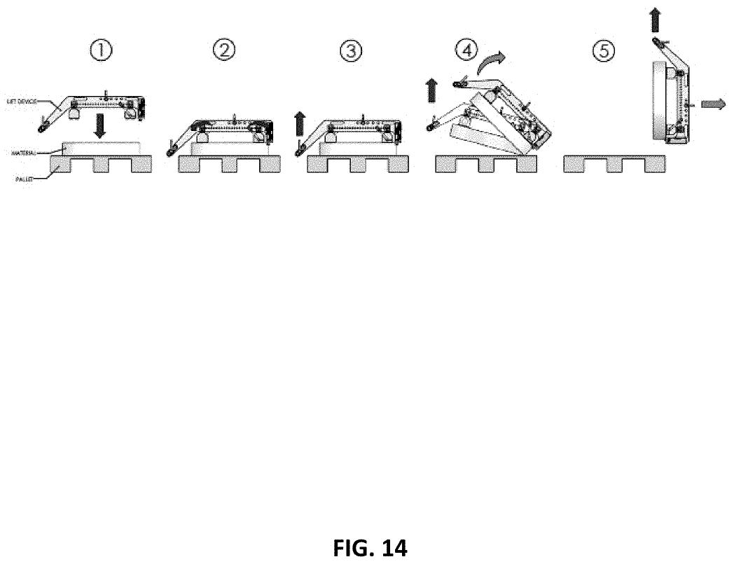

FIG. 14 shows an example of a tilt lift of a ferrous object using one embodiment of the lift device. Referring to FIG. 14, the lifting device is position over the objected and lowered into place using a pulley or crane operatively associated with a shackle attached to the horizontal lifting point (50). The magnets are engaged. The shackle attached to the horizontal lifting point (50) is detached and shackle attached to tilt lifting point (30) is attached to the pulley or crane. The object is tilted lifted off the pallet and optionally moved using a pulley or crane operatively associated with a shackle attached to the title lifting points (30).

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A lifting device comprising an elongated frame, the elongated frame having a first end, body and a second end, the first end extending at an obtuse angle from the body and having one or more tilt lifting points configured to receive a lift shackle, the body comprising one or more reversible coupling device attachment points and one or more horizontal lifting points configured to receive a lift shackle; at least one lift shackle connected to a tilt lifting point or a horizontal lifting point; and at least one reversible coupling device.

2. The lifting device of claim 1, comprising at least two reversible coupling devices.

3. The lifting device of claim 1, wherein the reversible coupling device is an area gripping device, automatic suction cup device, electromagnetic device, manual suction cup device, and manual magnetic device.

4. The lifting device of claim 1, wherein the frame comprises expanded platform for mounting the reversible coupling device(s).

5. The lifting device of claim 1, wherein the reversible coupling devices are mounted in line.

6. The lifting device of claim 1, wherein the reversible coupling devices are mounted not in line.

7. A lifting device comprising:
an elongated flat frame, the elongated flat frame having a first end, body and a second end, the first end extending at an obtuse angle from the body and having one or more tilt lifting points configured to receive a lift shackle, the body comprising one or more magnet attachment points and one or more horizontal lifting points configured to receive a lift shackle;
at least one lift shackle connected to a tilt lifting point or a horizontal lifting point; and
at least one magnetic lifter.

8. The lifting device of claim 7, comprising at least two magnetic lifters.

9. The lifting device of claim 7, wherein the frame comprises expanded platform for mounting magnetic lifter(s).

10. The lifting device of claim 7, wherein the magnetic lifters are mounted in line.

11. The lifting device of claim 7, wherein the reversible coupling devices are mounted not in line.

12. The lift device of claim 1, comprising a plurality of tilt lifting points.

13. The lift device of claim 1, comprising a plurality of horizontal lifting points.

14. The lift device of claim 1, comprising a plurality of attachment points.

15. The lifting device of claim 1, comprising two or more spaced apart reversible coupling devices or magnetic lifters.

16. The lifting device of claim 6, wherein the at least one magnetic lifter is a suction lifter.

17. The lifting device of 6, wherein the at least one magnetic lifter comprises a toggle or on/off handle.

18. The lifting device of claim 1 wherein the one or more tilt lifting points and/or one or more horizontal lifting points are reinforced holes in the frame.

19. The lifting device of claim 1, wherein the at least one reversible coupling devices or at least one magnetic lifter comprises one or more attachment means for attachment to the frame.

20. The lifting device of claim 1, wherein the one or more attachment points are holes in the frame.

21. The lifting device of claim 20, wherein the one or more attachment means are two L brackets, each having a hole and wherein the reversible coupling device or magnetic lifter is secured to the frame by a removable pin.

22. The lifting device of claim 1, wherein the frame comprises at the second end a mechanical lift support or foot.

23. The lifting device of claim 22, wherein the foot comprises rollers or wheels.

24. A lifting device comprising:
an elongated flat frame, the elongated flat frame having a first end, body and a second end, the first end extending at an obtuse angle from the body and having one or more tilt lifting points configured to receive a lift shackle, the body comprising one or more magnet attachment points and one or more horizontal lifting points configured to receive a lift shackle;
at least one lift shackle connected to a tilt lifting point or a horizontal lifting point; and
at least one suction cup lifter.
